(19) United States
(12) Patent Application Publication
(10) Pub. No.: US 2024/0315291 A1
(43) Pub. Date: Sep. 26, 2024

(54) PROTEIN FREE VEGETABLE WHIPPING CREAM

(71) Applicant: DUPONT NUTRITION BIOSCIENCES APS, Kongens Lyngby (DK)

(72) Inventor: Kim Dahl, Kongens Lyngby (DK)

(21) Appl. No.: 18/261,681

(22) PCT Filed: Feb. 3, 2022
(86) PCT No.: PCT/EP2022/052595

§ 371 Date: Jul. 17, 2023

(30) Foreign Application Priority Data
Feb. 4, 2021 (EP) 21155244.3

(51) Int. Cl. A23L 9/20

(52) U.S. Cl. CPC A23L 9/24

(57) ABSTRACT

A protein free vegetable whipping cream comprising a vegetable fat, an anionic emulsifier and a low viscosity hydroxypropylmethyl cellulose.

### FIELD OF THE INVENTION

The present invention relates to a protein free vegetable whipping cream, a food system to stabilize whipping cream, and processes for preparing the same. Specifically, the present invention relates to protein free vegetable whipping cream based on coconut oil/fat with a high foam stability.

### BACKGROUND OF THE INVENTION

The market for vegetable whipping cream, also commonly known as imitation cream or non-dairy cream, is increasing especially due to the vast variety of applications of the product. There are very low seasonal variations in the final product compared to those of dairy whipping cream and this is a benefit in many applications. Also, the significantly lower manufacturing costs relative to those involved in the manufacture of dairy whipping cream make the product increasingly popular.

Imitation cream is an oil in water (o/w) emulsion produced from vegetable fat, proteins, typically skimmed milk or Na-caseinate+water, sugars, emulsifiers/stabilizers and flavour. The applications vary from industrial to small-scale consumers whom often use the product for cake decoration.

Producing a good imitation cream with short whipping time, good overrun, a firm and stable foam and a good mouth-feel is not easily accomplished. There are many aspects which have an impact on its quality. The foam in the whipped imitation cream is typically fat stabilized, and to obtain good whipping a certain degree of protein desorption from fat globules should take place, and the fat should be partly agglomerated or even with partial coalescence. This 25 is achieved through selection of emulsifiers and by having a partial crystallization of the fat. However, the conditions for having good whipping properties, namely partial destabilization of the emulsion, also have a negative impact on the storage stability of the imitation cream, seen as a thickening of the cream in the bottle/container. This thickening can be so severe that the cream cannot be poured out of the container, and in some cases the whipping performance is also lost.

Various solutions have been attempted to improve storage stability of the imitation cream, e.g. addition of anionic emulsifiers, which through their charge and protein binding properties reduce fat globule interactions. However, the whipping properties (overrun and whipped cream firmness) are then reduced.

In many countries an important quality parameter for imitation cream is the tolerance towards acidification, e.g. through addition of fruit syrups. Typically, the protein will denaturate and aggregate, and a very firm and grainy whipped cream with low overrun is achieved.

In vegetable whipping cream or imitation cream important quality parameters are thus a stable cream which will not thicken during storage before aeration, for example in a bottle, and which remains able to aerate relatively quickly, giving a whipped cream with high overrun and a firm texture, which can be shaped and will keep the shape. Whipping cream stability in the bottle and good whipped cream properties are to some extent conflicting properties, improving the one leading to impairment of the other.

Protein, e.g. sodium caseinate, provides emulsion stability during manufacture, but is to some extent displaced from the oil droplet at low temperature to result in a partly destabilized emulsion. Initial foam stabilization will be obtained by protein at the air interface, gradually followed by fat particles. During whipping further desorption of protein from the oil/fat surface takes place which creates partial fat coalescence, which in turn further strengthens stabilization of air through a more coherent fat structure. Protein stabilization of emulsions is due to both steric and ionic stabilization, and protein desorption is achieved/accelerated through use of specific emulsifiers, e.g. mono-di glycerides.

There is a wish in the industry to reduce the cost of the whipping cream. As one of the costlier ingredients is protein, especially sodium caseinate, which is widely used as one of the most efficient protein-based emulsifiers, protein free whipping cream (or vegetable whipping cream with low levels of special proteins, like gelatin and acid tolerant protein) is becoming more and more popular. Also, for the vegan market protein free vegetable whipping cream is requested.

Cellulose ether products, such as methyl cellulose (MC), hydroxypropylmethyl cellulose (HPMC) and hydroxypropyl cellulose (HPC) are interfacial active hydrocolloids. Especially HPMC and HPC are efficient in both stabilizing emulsions and increasing whipping performance, and they are also able to be partly desorbed from fat globules by e.g. monoglyceride, in a similar manner as protein. HPC and HPMC are commonly used in whipping creams, including protein free whipping creams. Anionic emulsifiers, such as diacetyltartaric acid esters of monoglycerides (Datem) and sodium steroyl lactylate (SSL) bind to the oil droplet and stabilize the emulsion by ionic repulsion and furthermore also contribute to whipping. Datem and SSL are used in many whipping cream formulas, including protein free whipping cream.

In the last few decades, palm-based oils, such as palm oil or palm kernel oil has become one of the most used edible oils globally. Since it is solid at room temperature and its fractions deliver a wide range of functional melting profiles, palm-based oil has played an important role in the replacement of partially hydrogenated oils in food applications. However, since latest years there has been a demand for food products free of palm-based oil due to sustainability issues.

Accordingly, there is a need in the art to make protein free vegetable whipping creams, which do not contain any components derived from palm. Neither triglycerides nor monoglycerides derived from palm are possible options in palm-free creams. Furthermore, for some applications and for some parts of the market, there is also a desire to replace SSL with alternative anionic emulsifiers.

In the document WO2019/042994, it is described a solution of protein-free vegetable whipping creams with a high content of anionic emulsifier and low viscosity HPMC. However, the fat used in that solution was palm-based oil. Due to the demand of a solution to produce protein-free whipping cream based on palm-free, e.g. coconut fat, there is a need for different and/or improved stabilizer systems while maintaining the same foam stability. Coconut fat has different crystallization than palm kernel fat, and it was therefore needed to modify and improve the stabilizer system entirely.

### OBJECT OF THE INVENTION

It is an object of embodiments of the invention to provide an efficient protein free vegetable whipping agent additive and uses thereof for stabilizing protein free vegetable whipping creams containing a non-palm vegetable fat, such as a coconut fat as the main fat basis.

### SUMMARY OF THE INVENTION

It has surprisingly been found by the present inventors that it is possible to prepare a protein-free and also palm-free vegetable whipping cream having exceptionally good whipping properties, while maintaining excellent storage stability. This is achieved using a non-palm vegetable fat, such as coconut fat, preferably a fully hardened coconut fat in combination with the use of an anionic emulsifier, e.g. diacetyltartaric acid esters of monoglycerides (Datem) or SSL, preferably Datem, monodiglycerides, triglycerides, HPMC, an orto-, pyro-, or polyphosphate and/or a citrate salt, and a hydrocolloid, such as gellan gum. It has been found that whipping emulsifiers, e.g. monodiglycerides must be combined with a relatively high concentration of anionic emulsifier, e.g. Datem, to achieve good cream stability towards partial fat coalescence and high overrun and foam firmness upon whipping. Addition of HPMC further improves cream stability and whipping properties (overrun and foam firmness).

Accordingly, the present invention relates to a protein-free and palm-free vegetable whipping cream comprising preferably coconut fat, more preferably a fully hardened coconut fat, an anionic emulsifier, monodiglycerides, triglycerides, HPMC, an orto-, pyro-, or -polyphosphate and/or a citrate salt, and a hydrocolloid.

The invention further relates to a whipping agent additive comprising an anionic emulsifier, monodiglycerides, triglycerides, HPMC, orto-, pyro-, and/or polyphosphate and/or a citrate salt, and a hydrocolloid.

The invention further relates to use of a whipping agent additive as disclosed herein for providing low viscosity and stability during storage of the protein- and palm-free whipping cream, while keeping excellent whipping properties, i.e. firmness and aeration.

### BRIEF DESCRIPTION OF THE DRAWINGS

FIG. 1 shows whipping torque over time for a preferred embodiment 26% cream with fully hardened coconut fat 14 days after production at 5° C.

FIG. 2 shows whipping torque over time for a preferred embodiment cream with 26% fully hardened coconut and rapeseed fat protein free cream 1 day after production at 5° C.

FIG. 3 shows whipping torque over time for the same cream as in FIG. 1 but 5 weeks after production at 5° C.

### DETAILED DESCRIPTION OF THE INVENTION

### Definitions

In the present context, the term “whipping cream” means an o/w emulsion, which can be aerated by whipping, whereby fat globules collide and partially coalesce, forming aggregates or clusters that stabilize the foam structure. A “vegetable whipping cream” is an o/w emulsion, where the fat is vegetable fat or predominantly vegetable fat.

In the present context, the term “protein-free vegetable whipping cream” is well known in the marked as a vegetable whipping cream with low levels of special proteins, like gelatin and acid tolerant protein. It is defined as containing less than 0.3% protein or no protein, which is whipped cold (whipped cream) or alternatively during freezing (soft serve and ice cream). Protein free vegetable whipping cream is produced by substituting protein with other additives that possess similar properties.

In the present context, the term “palm-free vegetable whipping cream” is intended to mean a vegetable whipping cream with no palm kernel oil, palm fat or any component derived from palm.

In the present context, the term “whipping agent additive” is intended to mean a mixture of substances, some with interfacial properties that due to their adsorption dynamic and their presence at the gas-liquid interface and/or fat-liquid interface will facilitate the uptake and stabilization of gas cells when the product that contains the whipping agent is aerated. Also the “whipping agent additive” may contain one or more ingredients selected from the group consisting of hydrocolloids, triglycerides, sugars, sweeteners, bulking agents, e.g. maltodextrin or polydextrose, flavours, salts and up to 0.3% by weight of protein.

In the present context the term “emulsifier” means one or more chemical additives that encourage the suspension of one liquid in another, as in the mixture of oil and water in margarine, shortening, ice cream, and salad dressing.

In the present context “aeration” means to increase overrun compared to a product with no air incorporated.

In the present context “overrun” is a measure of the volume of air whipped into the product. In the present context “overrun” may be measured by any method known to the skilled person for example as described herein in the examples for example by filling whipped cream in a 240 ml beaker and weighing the 240 ml beaker and calculating % overrun=100×(240×1.02/weight of foam)−100. In one aspect, an acceptable overrun as measured according to this method is above 200%, more preferable above 250% and even more preferable above 300%, while keeping a foam firmness above 75 g/CM², more preferable above 90 g/CM² even more preferable above 110 g/CM².

### Embodiments

The whipping cream of the invention may conveniently comprise 0.1-0.7% by weight of the anionic emulsifier and 0.05-1% by weight of hydroxypropylmethyl cellulose, such as a low viscosity HPMC.

In a currently preferred embodiment, the whipping cream of the invention may comprise 0.2-0.5% by weight of the anionic emulsifier. The anionic emulsifier may be diacetyltartaric acid esters of mono- and diglycerides, such as a diacetyltartaric acid ester of mono- and diglycerides.

Furthermore, in one embodiment of the present invention, the HPMC preferably has a content of methoxyl groups from 28 to 30% and a content of hydroxypropoxyl groups from 7 to 12%. In another embodiment of the present invention the HPMC preferably has a content of methoxyl groups from 27 to 30% and content of hydroxypropoxyl groups from 4 to 7.5%.

The whipping cream of the present invention may comprise between 15% and 35% by weight of fat, preferably between 17% and 30% by weight of fat and more preferably between 20% and 30% by weight of fat.

The fat used in the invention is triglycerides, based on palm-free vegetable oils preferably selected from the group consisting of coconut oil, peanut oil, soybean oil, rapeseed oil, sunflower seed oil, cotton seed oil, olive oil, corn oil or grape seed oil, including fractionated, partially hydrogenated or fully hydrogenated versions of these oils. Preferred is coconut fat, such as unrefined and/or partially hydrogenated and/or fully hydrogenated coconut fat in combination with fully hydrated fats such as rapeseed or sunflower fat.

In some embodiments, the whipping cream of the invention has a rheology at 5° C. in the linear viscoelastic region characterized by a complex modulus below 25 Pa, in particular a rheology at 5° C. in the linear viscoelastic region characterized by a complex modulus below 10 Pa. Rheology determinations may be carried out as described in H. A. Barnes, J. F. Hutton and K. Walters, “An introduction to Rheology”, Chapter 3.5 (“Oscillatory Shear”), pp 46-50 (Elsevier Science B.V, 1996, Fourth Impression).

The whipping agent additive and the whipping cream may further comprise at least one or more emulsifier, such as selected from the group consisting of polyglycerol esters of fatty acids (PGE), polysorbates, monoglycerides, mono-diglycerides, lactic acid esters of mono- and diglycerides (lactems), diacetyltartaric acid esters of mono- and diglycerides (datems), citric acid esters of mono- and diglycerides (citrems), lecithins, sorbitan monostearates and combinations thereof.

The whipping agent additive and whipping cream of the invention may comprise one or more ingredients selected from the group consisting of hydrocolloids, sugars, sweeteners, bulking agents, e.g. maltodextrin or polydextrose, flavours, salts and up to 0.3% by weight of a protein such as gelatin. Examples of hydrocolloids are preferably selected from the group consisting of high acyl gellan, low acyl gellan, alginate, carrageenan, guar gum, locust bean gum, Konjack gum, tara gum, gum araric, and xanthan gum.

In accordance with the findings of the present inventors, the present whipping agent additive may be used for improving the stability of a protein free and palm-free vegetable whipping cream under fluctuating conditions during filling, transportation and storage. The present whipping agent additive may further be used for improving the stability of a protein free vegetable whipping cream under conditions of fluctuating fat crystallization behavior.

In an embodiment, the present invention relates to a whipped cream which is an aerated whipping cream as disclosed herein. A method for aeration of a whipping cream to obtain a whipped cream may comprise the following steps: providing a whipping cream as disclosed herein, and aerating said whipping cream to obtain said whipped cream. The whipping of the cream may be performed by any method for whipping cream known by a person skilled in the art e.g. by whipping with a whisk, aeration in an industrial aeration equipment such as in a Mondo mixer or Hansa mixer type or aerated from an aerosol can.

The whipped cream may conveniently be used as a topping for dessert or cake decoration, as ice cream, soft ice, mayonnaise or dressing such as salad dressing.

### Numbered Embodiments of the Invention

1. A protein-free vegetable whipping cream comprising:
a) 15-35% by weight of vegetable fat which is not derived from palm oil;
b) 0.1-0.7% by weight of an anionic emulsifier (e.g. DATEM);
30) c) 0.05-1% by weight of hydroxypropylmethyl cellulose (HPMC);
d) 0.01-2% by weight of a monodiglyceride;
e) 0.05-5% by weight of high melting point triglyceride having a drop point of minimum 50 degrees C.;
f) 0.03-0.25% by weight of an orto-, pyro-, and/or polyphosphate, a citrate salt or a blend thereof;
g) optionally 0-0.2% by weight of a polysorbate;
h) 0.005-0.5% by weight of a hydrocolloid, such as gellan gum;
i) optionally a sweetener and/or salts, and
j) water, such as up to 100%.

2. The whipping cream according to embodiment 1 wherein the HPMC has a viscosity of 0.02-1 Pa*s in a 2% aqueous solution at 20° C.

3. The whipping cream according to embodiments 1 or 2, in which the whipping cream has a rheology at 5° C. in the linear viscoelastic region by a complex modulus below 25 Pa, and/or a torque as measured in a whipping test described herein higher than about 1000; and/or a firmness above 75 g/CM² as measured at 5° C. on a Texture Analyzer TAXTp/t/s from Stable Micro Systems, wherein a 25.4 mm plunger is pressed 10 mm into the whipped cream at speed 1 mm/second, and maximum force is detected.

4. The whipping cream according to any one of the above embodiments, in which the palm-free vegetable fat is coconut fat, such as unrefined and/or partially hydrogenated and/or fully hydrogenated coconut fat.

5. The whipping cream according to any one of the above embodiments, in which the fat comprises a blend of coconut oil and another oil selected from the group of raps oil, sunflower seed, peanut oil, soybean oil, rapeseed oil, cotton seed oil, olive oil, corn oil or grape seed oil, including fractionated, partially hydrogenated or fully hydrogenated versions of these oils.

6. The whipping cream according to any one of the above embodiments, in which the palm-free vegetable fat is present in an amount at least about 16%, such as at least about 17, 19, 21, 23, 25, 27, 29, 31, 33%.

7. The whipping cream according to any one of the above embodiments, in which the palm-free vegetable fat is present in an amount less than about 31%, such less than about 29, 27, 25, 23, 21, 19, or 17%.

8. The whipping cream according to any one of the above embodiments, in which the anionic emulsifier is diacetyltartaric acid esters of mono- and diglycerides (datems).

9. The whipping cream according to any one of the above embodiments, in which the anionic emulsifier is present in an amount of at least about 0.2%, such as at least about 0.3, 0.4, 0.5, or 0.6%.

10. The whipping cream according to any one of the above embodiments, in which the anionic emulsifier is present in an amount less than about 0.7%, such as less than about 0.6, 0.5, 0.4, 0.3 or 0.2%.

11. The whipping cream according to any one of the above embodiments, in which the hydroxypropylmethyl cellulose (HPMC) is present in an amount of at least about 0.1%, such as at least about 0.2, 0.3, 0.4, 0.5, 0.6, 0.7, 0.8, or 0.9%.

12. The whipping cream according to any one of the above embodiments, in which the hydroxypropylmethyl cellulose (HPMC) is present in an amount of not more than about 0.9%, such as not more than about 0.8, 0.7, 0.6, 0.5, 0.4, 0.3, 0.2, or 0.1%.

13. The whipping cream according to any one of the above embodiments, in which the monodiglyceride is present in an amount of at least about 0.02%, such as 0.04, 0.06, 0.08, 0.1, 0.2, 0.3, 0.4, 0.5, 0.6, 0.7, 0.8, 0.9, 1.0, 1.2, 1.4, 1.6, or 1.8%.

14. The whipping cream according to any one of the above embodiments, in which the monodiglyceride is present in an amount of not more than about 1.8%, such as not more than about 1.6, 1.4, 1.2, 1.0, 0.9, 0.8, 0.7, 0.6, 0.5, 0.4, 0.3, 0.2, 0.1, 0.08, 0.06, 0.04, or 0.02%.

15. The whipping cream according to any one of the above embodiments, in which the high melting point triglyceride is present in an amount of at least about 0.1%, such as 0.2, 0.3, 0.4, 0.5, 0.6, 0.7, 0.8, 0.9, 1.0, 1.1, 1.2, 1.3, 1.4, 1.5, 2.0, 2.5, 3.0, 3.5, 4.0, or 4.5%.

16. The whipping cream according to any one of the above embodiments, in which the high melting point triglyceride is present in an amount of not more than about 1.4%, such as not more than about 4.5, 4.0, 3.5, 3.0, 2.5, 2.0, 1.5, 1.4, 1.3, 1.2, 1.1, 1.0, 0.9, 0.8, 0.7, 0.6, 0.5, 0.4, 0.3, or 0.2%.

17. The whipping cream according to any one of the above embodiments, in which the orto-pyro-polyphosphate, citrates salt or a blend thereof is present in an amount of at least about 0.04%, such as 0.06, 0.08, 0.1, 0.12, 0.14, 0.16, 0.18, 0.2, 0.22, or 0.24.

18. The whipping cream according to any one of the above embodiments, in which the orto-pyro-polyphosphate, citrates salt or a blend thereof is present in an amount of not more than about 0.24%, such as not more than about 0.22, 0.20, 0.18, 0.16, 0.14, 0.12, 0.10, 0.08, 0.06, or 0.04%.

19. The whipping cream according to any one of the above embodiments, in which the hydrocolloid, such as a gellan gum is present in an amount of at least about 0.006%, such as 0.008, 0.010, 0.012, 0.014, 0.016, 0.018, 0.02, 0.03, 0.04, 0.05, 0.06, 0.07, 0.08, 0.09, 0.1, 0.2, 0.3, or 0.4%.

20. The whipping cream according to any one of the above embodiments, in which the a polysorbate can be present in amounts up to 0.2% such as 0.2, 0.18; 0.16, 0.14, 0.12, 0.10, 0.08, 0.06, 0.04, 0.04, 0.02 or 0.0%.

21. The whipping cream according to any one of the above embodiments, in which the hydrocolloid, such as gellan gum is present in an amount of not more than about 0.4%, such as not more than about 0.3%, such as 0.2, such as 0.1, such as 0.09, such as 0.08, such as 0.07, such as 0.06, such as 0.05%, such as not more than about 0.04, 0.03, 0.02, 0.018, 0.016, 0.014, 0.012, 0.010, 0.008, or 0.006%.

22. The whipping cream according to any one of the above embodiments, in which the orto-pyro-polyphosphate, citrates salt or a blend thereof is selected from disodium phosphate and/or tripotassium citrate, and/or trisodium citrate, and/or sodium tripolyphosphate.

23. The whipping cream, according to any one of the above embodiments, wherein the anionic emulsifier is not sodium stearoyl lactylate (SSL).

24. The whipping cream according to any one of the above embodiments, wherein the ratio between the anionic emulsifier and the HPMC is between 1:3 and 8:1.

25. The whipping cream according to any one of the above embodiments, wherein the ratio between the hydrocolloid, such as HA gellan gum, and the HPMC is between 1:100 and 1:1.

26. The whipping cream according to any one of the above embodiments, wherein the hydrocolloid is selected from the group consisting of starch, tara gum, gum Arabic, konjac gum, high acyl gellan (HA gellan), low acyl gellan, guar gum, locust bean gum, alginate, carrageenan, pectin and xanthan gum.

27. The whipping cream according to any one of the above embodiments, wherein the high melting point triglyceride has a dropping point in the range of 50-80° C., such as in the range of 55-75° C., such as a high melting point triglyceride derived from rapeseed.

28. The whipping cream according to any one of the above embodiments, further comprising any one or more compounds selected from sugars, sweeteners, bulking agents, such as maltodextrin or polydextrose, flavours, and salts.

29. A protein- and palm-free vegetable whipping cream comprising:
(a) 20-30% by weight of a blend of coconut fat and rapeseed fat in a ratio between 10:1 and 1:10, such as between 8:1 and 1:8, such as between 6:1 and 1:6, such as between 4:1 and 1:4, such as between 2:1 and 1:2, such as 1:1;
(b) 0.2-0.5% by weight of an anionic emulsifier being diacetyltartaric acid esters of mono- and diglycerides, wherein the tartaric acid content between 20-27%;
(c) 0.05-1% by weight of a low viscosity hydroxypropylmethyl cellulose (HPMC) with a viscosity of 0.02-1 Pa*s in a 2% aqueous solution at 20° C.;
(d) 0.01-2% by weight of monodiglyceride;
(e) 0.1-1.5% by weight of high melting point triglyceride with a dropping point of 60-80° C., preferably 65-75° C.;
(f) up to 0.1% by weight of disodium or dipotassium phosphate;
(g) up to 0.1% by weight of trisodium citrate;
(h) up to 0.1% by weight of sodium tripolyphosphate;
(g) 0.01-0.5% by weight of a hydrocolloid, such as high acyl gellan gum;
(f) water, such as up to 100%.

30. A whipping agent additive comprising the ingredients as defined in any one of embodiments 1-29 except for water and the palm-free vegetable fat.

31. Use of a whipping agent additive as described in embodiment 30 in a protein-free and palm-free vegetable whipping cream, as described in embodiments 1-29.

32. A method for the preparation of a whipping cream, the method comprising the steps of:
a) melting fat and emulsifiers as defined in any one of embodiments 1-29;
b) dispersing all remaining ingredients as defined in any one of embodiments 1-29 in heated water;
c) dispersing fat blend from step a) into water phase derived from step b); and
d) store until use.

### EXPERIMENTAL SECTION

### Example 1

### Material and Methods

Creams were made in accordance with the formulation in table 1 with fully hardened (FH) coconut fat and the below procedure.

TABLE 1
Protein free whipping cream formulations.
INGREDIENTS IN % (by weight)

| | | 1 |
|---|---|---|
| Water (Ion) | % | 59.740 |
| Neosorb ® P60 - Sorbitol (Powder) | % | 1.000 |
| Sucrose | % | 12.000 |
| Di-sodium phosphate | % | 0.100 |
| Trisodium citrate | % | 0.070 |
| DIMODAN ® MO 90/D | % | 0.060 |
| Distilled Monoglyceride | | |
| DIMODAN ® HR Distilled | % | 0.500 |
| Monoglyceride | | |
| METHOCEL ™ F50 FDG. | % | 0.500 |
| GRINDSTED ® Gellan VEG 200 | % | 0.030 |
| GRINDSTED ® SSL R 55 VEG-K | % | 0.500 |
| GRINDSTED ® PS 104 NP | % | 0.350 |
| Fully hardened coconut oil | % | 25.150 |
| Total % | | 100 |

### Indirect UHT-THE

1. Melt fat and emulsifiers at 70-80° C.
2. Heat water to 65° C. and disperse all remaining ingredients in the water at high-shear mixing
4. Disperse fat blend in the 65° C. water phase
5. Make pre-emulsion on Silverson, 5700 rpm for 3 minutes
Keep at 67° C. for 30 minutes with gently agitation
6. UHT processing at 142° C. for 3 seconds
7. Cool to 75° C. and homogenize down-stream at 150/30 bar
8. Cool to 12° C. before filling.
9. Store in cold storage

### Measurements

Viscosity is measured directly in the bottles with Anton Paar ViscoQC 100 at 30 RPM with spindle RH6 at 5° C.

Whipping test is conducted on a Hobart with continuous measuring of the torque. 400 grams of 5° C. cream is used in each test. Speed 3 is applied, and the whipping is stopped at max torque.

Firmness measurements The whipped cream firmness was measured at 5° C. on a Texture Analyzer TAXTp/t/s from Stable Micro Systems. A 25.4 mm plunger was pressed 10 mm into the whipped cream at speed 1 mm/second, and maximum force was detected.

### Foam Overrun % is Defined as:

$${Overrun}_{x min} = 100 \% \cdot \frac{Total {volume}_{x min} [ mL ]}{( \frac{weight of sample [ g ]}{1.02 [ \frac{g}{mL} ]} )} - 100 \%$$

### Results and Discussion

TABLE 2
Cream characteristics two days after filling at 5° C.

| | 1 |
|---|---|
| Trial | FH coconut oil |
| Cream Viscosity | 1.7 |
| (Pa*s) | |
| Whipping time (s) | 151 |
| Torque (g) | 1780 |
| OR % | 288 |
| Foam firmness | 56 |
| (g/cm\hat{ }2) | |

TABLE 3
Cream characteristics at 5° C. two weeks after filling.

| | 1 |
|---|---|
| Trial | FH coconut oil |
| Cream Viscosity | 0.97 |
| (Pa*s) | |
| Whipping time (s) | 105 |
| Torque (g) | 2550 |
| OR % | 292 |
| Foam firmness | 96 |
| (g/cm\hat{ }2) | |

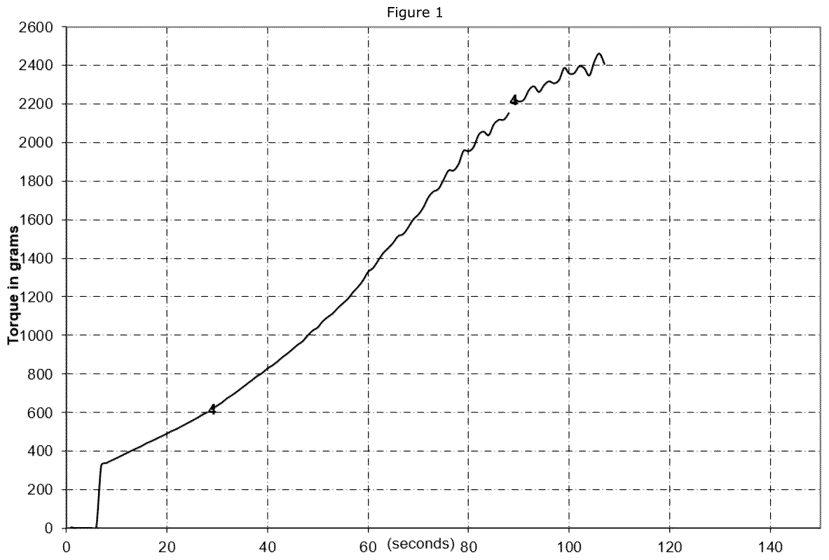

The creams made with the fully hardened coconut fat in accordance with table 1 were able to whip to the desired foam firmness as shown in tables 2 and 3 above. Whipping curve can be seen in FIG. 1.

### Example 2

### Material and Methods

Creams for this example were made in accordance with the formulation in table 4 and procedure described for example 1.

Fully hardened (FH) Coconut was used.

TABLE 4

| 2 | | 3 | | 4 | |
|---|---|---|---|---|---|
| 25% FH Coconut fat | | 25% FH Coconut fat | | 25% FH Coconut fat | |
| Mono di 1 | 0.45% | Mono di 1 | 0.45% | Mono di 1 | 0.45% |
| Mono di 2 | 0.05% | Mono di 2 | 0.05% | Mono di 2 | 0.04% |
| Triglyceride | 0.35% | Triglyceride | 0.35% | Triglyceride | 0.35% |
| HPMC | 0.5% | HPMC | 0.5% | HPMC | 0.5% |
| SSL | 0.5% | Datem | 0.1% | Datem | 0.25% |
| Disodium | 0.1% | Disodium | 0.1% | Disodium | 0.1% |
| Phosphate | | Phosphate | | Phosphate | |
| Tripotassium | 0.07% | Tripotassium | 0.07% | Tripotassium | 0.07% |
| citrate | | citrate | | citrate | |
| Gellan Gum | 0.035% | Gellan Gum | 0.035% | Gellan Gum | 0.035% |
| Polysorbate 80 | 0.15% | Polysorbate 80 | 0.15% | Polysorbate 80 | 0.15% |
| 5 | | 6 | | 7 | |
| 25% FH Coconut fat | | 25% FH Coconut fat | | 25% FH Coconut fat | |
| Mono di 1 | 0.45% | Mono di 1 | 0.45% | Mono di 1 | 0.45% |
| Mono di 2 | 0.04% | Mono di 2 | 0.04% | Mono di 2 | 0.04% |
| Triglyceride | 0.35% | Triglyceride | 0.35% | Triglyceride | 0.35% |
| HPMC | 0.5% | HPMC | 0.5% | HPMC | 0.5% |
| Datem | 0.4% | Datem | 0.55% | Datem | 0.7% |
| Disodium | 0.1% | Disodium | 0.1% | Disodium | 0.1% |
| Phosphate | | Phosphate | | Phosphate | |
| Tripotassium | 0.07% | Tripotassium | 0.07% | Tripotassium | 0.07% |
| citrate | | citrate | | citrate | |
| Gellan Gum | 0.035% | Gellan Gum | 0.035% | Gellan Gum | 0.035% |
| Polysorbate 80 | 0.15% | Polysorbate 80 | 0.15% | Polysorbate 80 | 0.15% |

TABLE 5
Speed 3 until max torque
Whipped 26 hours maturation

| Trial no. | 2 | 3 | 4 | 5 | 6 | 7 |
|---|---|---|---|---|---|---|
| Cream viscosity | 1.2 | 2 | 1.065 | 0.9 | 0.9 | 0.87 |
| (Pa*s) | | | | | | |
| Whipping time | 98 | 125 | 119 | 138 | 140 | 152 |
| (s)* | | | | | | |
| Torque (g) | 1932 | 1642 | 1758 | 2400 | 2464 | 2485 |
| OR % | 211 | 219 | 220 | 231 | 254 | 275 |
| Foam firmness | 100 | 80 | 113 | 111 | 113 | 80 |
| (g/cm\hat{ }2) | | | | | | |

According to table 3 and 4 best performance is obtained with Datem levels between 0.25 and 0.55% Datem. SSL and Datem performance at a dosage level of roughly 0.5% is comparable. The creams performed surprisingly well after only 26 hours maturation.

TABLE 6

| 8 | | 9 | | 10 | |
|---|---|---|---|---|---|
| 25% FH coconut fat | | 25% FH coconut fat | | 25% FH coconut fat | |
| Mono di 1 | 0.45% | Mono di 1 | 0.55% | Mono di 1 | 0.45% |
| Mono di 2 | 0.15% | Mono di 2 | 0.1% | Mono di 2 | 0.05% |
| Triglyceride | 0.35% | Triglyceride | 0.35% | Triglyceride | 0.35% |
| HPMC | 0.5% | HPMC | 0.5% | HPMC | 0.5% |
| Datem | 0.5% | Datem | 0.5% | Datem | 0.5% |
| Disodium | 0.1% | Disodium | 0.1% | Disodium | 0.1% |
| Phosphate | | Phosphate | | Phosphate | |
| Tripotassium | 0.07% | Tripotassium | 0.07% | Tripotassium | 0.07% |
| citrate | | citrate | | citrate | |
| Gellan Gum | 0.035% | Gellan Gum | 0.035% | Gellan Gum | 0.035% |

TABLE 7

| Trial no. | 8 | 9 | 10 |
|---|---|---|---|
| Cream | 3 | 2 | 1.2 |
| viscosity | | | |
| (Pa*s) | | | |
| Whipping | 125 | 103 | 155 |
| time (s) | | | |
| Torque (g) | 1900 | 2334 | 1575 |
| OR % | 238 | 247 | 259 |
| Foam | 140 | 174 | 40 |
| firmness | | | |
| (g) | | | |

According to table 6 and 7 inclusion and increasing concentrations of unhardened mono di can increase foam firmness 24 hours after filling and decrease whipping time.

TABLE 9

| Trial no. | 11 | |
|---|---|---|
| | FH Coconut and Rapeseed fat | 25% |
| | No protein | |
| | Mono di 1 | 0.5% |
| | Mono di 2 | 0.045% |
| | Triglyceride | 0.45% |
| | HPMC | 0.425% |
| | Datem | 0.386% |
| | Disodium Phosphate | 0.05% |
| | Trisodium citrate | 0.05% |
| | Sodium tripolyphosphate | 0.05% |
| | Gellan Gum | 0.028% |
| Cream viscosity (Pa*s) | 0.4 | |
| at 5° C. | | |
| Whipping time (s) | 97 | |
| Torque (g) | 2680 | |
| OR % | 325 | |
| Foam firmness (g/cm\hat{ }2) | 94 | |
| Cream Synereses after one | 0 | |
| week at 5° C. (mm) | | |

Table 9: Results 26 hours after manufacturing.

5 weeks after filling

TABLE 10

| Trial no. | 11: |
|---|---|
| Cream viscosity (Pa*s) | 1.1 |
| at 5 C. | |
| Whipping time (s) | 93 |
| Torque (g) | 3280 |
| OR % | 305 |
| Foam firmness (g/cm\hat{ }2) | 122 |
| Cream Synereses (mm) | 0 |

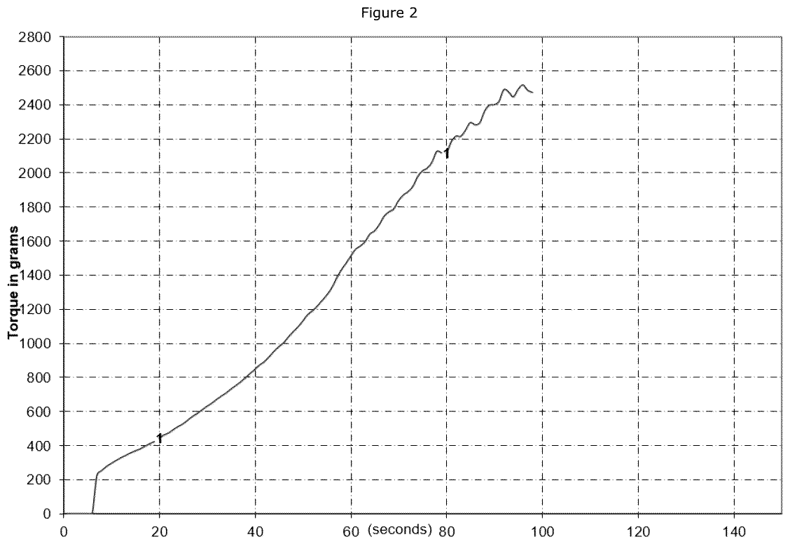

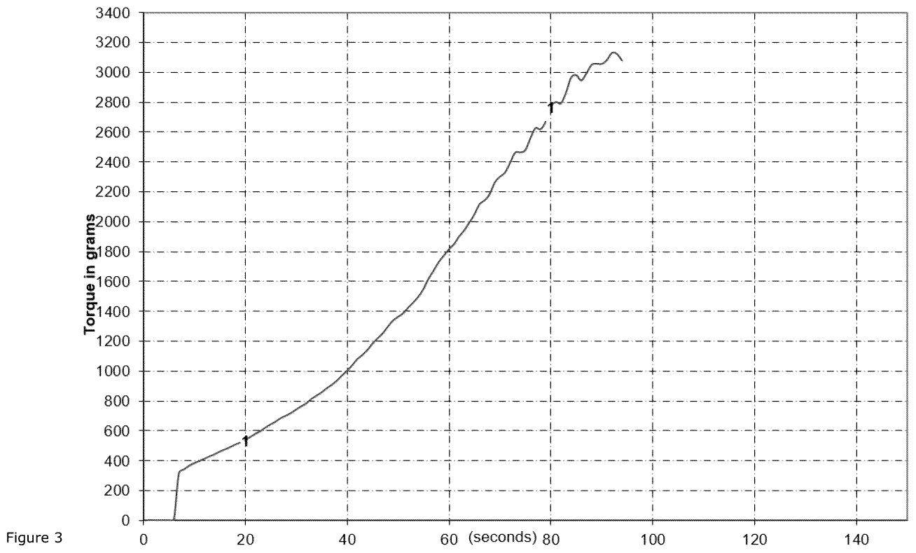

As seen in table 9 the combination of FH coconut and rapeseed fat resulted in very good whipping performance 26 hours after filling. During the following weeks whipping performance increased further as seen in table 10. Whipping curves are seen in FIGS. 2 and 3.

### Results Discussion

Trials without added high melting triglyceride resulted in low OR and hardly any foam firmness 24 hours after filling. When a small amount of triglyceride is added a much better foam is formed especially if there is also added significant amounts of mono di with unhardened fatty acids. A high amount of unsaturated mono di do however results in severe viscosity increases in the cream and consequently the shelf is reduced. So, the amount in the formulation object of this invention has been adjusted to a range that provides the desired viscosity to the application.

By adding some hardened rapeseed oil to the coconut oil the percentage of low melting fatty acids are reduced and the creams whipping properties improve significantly.

1. A vegetable whipping cream, containing less than 0.3% of protein, comprising:
a) 15-35% by weight of vegetable fat, which is not palm oil;
b) 0.1-0.7% by weight of an anionic emulsifier;
c) 0.05-1% by weight of hydroxypropylmethyl cellulose (HPMC);
d) 0.01-2% by weight of a monodiglyceride;
e) 0.05-5% by weight of high melting point triglyceride having a drop point of minimum 50° C.;
f) 0.03-0.25% by weight of an orto-, pyro-, and/or polyphosphate, a citrate salt or a blend thereof;
g) 0.005-0.5% by weight of a hydrocolloid;
h) water.

2. The whipping cream according to claim 1, wherein the HPMC has a viscosity of 0.02-1 Pa*s in a 2% aqueous solution at 20° C.

3. The whipping cream according to claim 1, in which the whipping cream has:
a rheology at 5° C. in the linear viscoelastic region by a complex modulus below 25 Pa;
a torque as measured in a whipping test described herein higher than about 1000;
a firmness above 75 g/CM² as measured at 5° C. on a Texture Analyzer TAXTp/t/s from Stable Micro Systems, wherein a 25.4 mm plunger is pressed 10 mm into the whipped cream at speed 1 mm/second, and maximum force is detected.

4. The whipping cream according to claim 1, in which the vegetable fat is coconut fat.

5. The whipping cream according to claim 1, in which the fat comprises a blend of coconut oil and another oil selected from the group of raps oil, sunflower seed, peanut oil, soybean oil, rapeseed oil, cotton seed oil, olive oil, corn oil and grape seed oil.

6. The whipping cream according to claim 1, in which the vegetable fat is present in an amount at least about 16%.

7. The whipping cream according to claim 1, in which the anionic emulsifier is diacetyltartaric acid esters of mono- and diglycerides (datems).

8. The whipping cream according to claim 1, in which the anionic emulsifier is present in an amount of at least about 0.2%.

9. The whipping cream according to claim 1, in which the monodiglyceride is present in an amount of at least about 0.02%.

10. The whipping cream according to claim 1, in which the high melting point triglyceride is present in an amount of at least about 0.1%.

11. The whipping cream according to claim 1, in which the orto-pyro-polyphosphate, citrates salt or a blend thereof is present in an amount of at least about 0.04%.

12. The whipping cream according to claim 1, in which the orto-pyro-polyphosphate, citrates salt or a blend thereof is disodium phosphate, tripotassium citrate, trisodium citrate, and/or sodium tripolyphosphate.

13. The vegetable whipping cream, according to claim 1, comprising:
(a) 20-30% by weight of a blend of coconut fat and rapeseed fat in a ratio between 10:1 and 1:10;
(b) 0.2-0.5% by weight of an anionic emulsifier being diacetyltartaric acid esters of mono- and diglycerides;
(c) 0.05-1% by weight of hydroxypropylmethyl cellulose (HPMC) with a viscosity of 0.02-1 Pa*s in a 2% aqueous solution at 20° C.;
(d) 0.01-2% by weight of monodiglyceride;
(e) 0.1-1.5% by weight of high melting point triglyceride with a dropping point of 50-80° C.;
(f) up to 0.1% by weight of disodium or dipotassium phosphate;
(g) up to 0.1% by weight of trisodium citrate;
(h) up to 0.1% by weight of sodium tripolyphosphate;
(i) 0.01-0.5% by weight of a hydrocolloid;
(i) water.

14. A whipping agent additive comprising the ingredients as defined in claim 1 except for water and the vegetable fat.

15. A vegetable whipping cream, wherein the vegetable whipping cream comprises a whipping agent additive as described in claim 14.
